(19) United States
(12) Patent Application Publication
(10) Pub. No.: US 2020/0104641 A1
(43) Pub. Date: Apr. 2, 2020

(54) MACHINE LEARNING USING SEMANTIC CONCEPTS REPRESENTED WITH TEMPORAL AND SPATIAL DATA

(71) Applicant: Philip Alvelda, VII, Arlington, VA (US)

(72) Inventor: Philip Alvelda, VII, Arlington, VA (US)

(21) Appl. No.: 16/589,030

(22) Filed: Sep. 30, 2019

Related U.S. Application Data
(60) Provisional application No. 62/739,864, filed on Oct. 2, 2018.
(60) Provisional application No. 62/739,895, filed on Oct. 2, 2018.
(60) Provisional application No. 62/739,364, filed on Oct. 1, 2018.
(60) Provisional application No. 62/739,287, filed on Sep. 30, 2018.
(60) Provisional application No. 62/739,297, filed on Sep. 30, 2018.
(60) Provisional application No. 62/739,301, filed on Sep. 30, 2018.
(60) Provisional application No. 62/739,208, filed on Sep. 29, 2018.
(60) Provisional application No. 62/739,210, filed on Sep. 29, 2018.
(60) Provisional application No. 62/739,207, filed on Sep. 29, 2018.

(51) Int. Cl. G06K 9/62; G06N 5/02; G06N 3/08; G06N 5/04; G06N 20/00

(52) U.S. Cl. CPC G06K 9/6257; G06N 5/02; G06K 9/6288; G06N 5/04; G06N 20/00; G06N 3/08

(57) ABSTRACT

Various embodiments may include a machine-readable medium, computing device, and/or computer-implemented method for deriving inferences associated with semantic concepts using machine learning. In one embodiment, a machine learning model is trained to derive inferences associated with semantic concepts using a distributed knowledge graph (DKG) data structure. The DKG data structure represents semantic concepts from a training dataset as a set of vectors in a vector space, wherein elements of the vectors correspond to meta-semantic parameters associated with the semantic concepts. The meta-semantic parameters include: a temporal parameter to represent timestamps associated with the semantic concepts; and a spatial parameter to represent physical locations associated with the semantic concepts. An input vector with elements corresponding to the meta-semantic parameters is obtained based on data captured by sensor(s). An inference associated with semantic concept(s) corresponding to the input vector is then derived based on the machine learning model.

### CROSS REFERENCE TO RELATED APPLICATIONS

This application claims the benefit of and priority from U.S. Provisional Patent Application No. 62/739,207 entitled “Data Representations And Architectures, Systems, And Methods For Multi-Sensory Fusion, Computing, And Cross-Domain Generalization,” filed Sep. 29, 2018; from U.S. Provisional Patent Application No. 62/739,208 entitled “ Data representations and architectures for artificial storage of abstract thoughts, emotions, and memories,” filed Sep. 29, 2018; from U.S. Provisional Patent Application No. 62/739,210 entitled “Hardware and software data representations of time, its rate of flow, past, present, and future,” filed Sep. 29, 2018; from U.S. Provisional Patent Application No. 62/739,864, entitled “Machine Learning Systems That Explicitly Encode Coarse Location As Integral With Memory,” filed Oct. 2, 2018; from U.S. Provisional Patent Application No. 62/739,287 entitled “Distributed Meta-Machine Learning Systems, Architectures, And Methods For Distributed Knowledge Graph That Combine Spatial And Temporal Computation,” filed Sep. 30, 2018; from U.S. Provisional Patent Application No. 62/739,895 entitled “Efficient Neural Bus Architectures That Integrate And Synthesize Disparate Sensory Data Types,” filed Oct. 2, 2018; from U.S. Provisional Patent Application No. 62/739,297 entitled “Machine Learning Data Representations, Architectures & Systems That Intrinsically Encode & Represent Benefit, Harm, And Emotion To Optimize Learning,” filed Sep. 30, 2018; from U.S. Provisional Patent Application No. 62/739,301 entitled “Recursive Machine Learning Data Representations, Architectures That Represent & Simulate ‘Self,’‘Others,’‘Society’ To Embody Ethics & Empathy,” filed Sep. 30, 2018; and from U.S. Provisional Patent Application No. 62/739,364 entitled “Hierarchical Machine Learning Architecture, Systems, and Methods that Simulate Rudimentary Consciousness,” filed Oct. 1, 2018, the entire disclosures of which are incorporated herein by reference.

### FIELD

Various embodiments generally relate to the field of machine learning and artificial intelligence, and more particularly, to semantic concepts represented using spatial and temporal data for machine learning and artificial intelligence systems.

### BACKGROUND

Most commercial machine learning and Al systems operate on hard physical sensor data such as data based on images from light intensity falling on photosensitive pixel arrays, videos, Light Detection and Ranging (LIDAR) streams, audio recordings. The data is typically encoded in industry standard binary formats. However, there are no established methods to systematize and encode more abstract, higher level concepts including emotions such as fear or anger. In addition, there are no taxonomies, for naming in digital code format, that can preserve semantic information present in data and how aspects of such information are inter-related.

Prior technologies have relied on general knowledge-graph type data stores that represent both concrete objects and sensory information as well as abstract concepts as a single semantic concept where each node for each semantic concept corresponds to one dimension of the semantic concept. In addition, according to the prior art, semantic concepts defined as respective nodes that are related are typically conceptualized as having a relational link therebetween, forming a typical prior art related concepts architecture and data structure.

However, there are several important limitations to the related concepts architecture described above. First, traditional knowledge graphs scale poorly when broad knowledge domains cover millions of concepts, growing their interconnection densities into an order of trillions or more. Secondly, the computational tools that use algebraic inversions of link matrices to perform simple relational inferences across the knowledge graphs no longer work if there is any link or semantic node complexity, such as probabilistic or dependent node structures. These two factors in concert are the primary reason that classical inference machines that operate on knowledge graphs perform well only on limited problem domains. Once the problem space grows to encompass multiple domains, and the number of concepts grows large, they typically fail.

Another key limitation of the classical knowledge graph data stores is that they have no intrinsic mechanism to handle imprecision, locality, or similarity, other than to just add more semantic concept nodes and more links between them, contributing to the intractability of scaling.

### BRIEF DESCRIPTION OF THE DRAWINGS

Advantages of embodiments may become apparent upon reading the following detailed description and upon reference to the accompanying drawings.

FIG. 1 illustrates a three dimensional graph of a brain including mapped regions thereof, and of associated meta-semantic nodes within a three dimensional graph according to one embodiment;

FIG. 2 illustrates juxtaposed graphs of two distributed knowledge graphs (DKGs) within a 90+ dimensional vector space showing trajectories between nodes within the DKGs according to one embodiment;

FIG. 3 illustrates an energy map in a two-dimensional rendition of a DKG according to one embodiment;

FIG. 4 illustrates a computer system to perform semantic fusion according to one embodiment;

FIG. 5 illustrates a process according to one embodiment;

FIG. 6 illustrates a process according to another embodiment;

FIG. 7 illustrates an architecture of a system to be used to carry out one or more processes according to embodiments; and

FIG. 8 illustrates a process for deriving machine learning inferences from semantic concepts represented using temporal and spatial data.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Overview

Embodiments present novel families of, architectures, data structures, designs, and instantiations of a new type of Distributed Knowledge Graph (DKG) computing engine based on recent scientific discoveries in neuroscience and information theory. The instant disclosure provides a description, among others, of the manners in which data may be represented within a new DKG, and of the manner in which DKG may be used to enable significantly higher performance computing on a broad range of applications, in this way advantageously extending the capabilities of traditional machine learning and Al systems.

A novel feature of embodiments concerns devices, systems, products and method to represent data structures representing broad classes of both concrete object information and sensory information, as well as broad classes of abstract concepts, in the form of digital and analog electronic representations in a synthetic computing architecture, using a computing paradigm closely analogous the manner in which a human brain processes information. In contrast to the “one-node-per-concept dimension” strategy of the state of the art Knowledge Graph (KG) as described above, and as used for example for simple inference and website search applications, new DKG architectures and algorithms are adapted to represent a single concept by associating such concept with a characteristic distributed pattern of levels of activity across a number of Meta-Semantic Nodes (MSNs), such as fixed MSNs. By “fixed,” what is meant here is that once the number of dimensions is chosen, it does not change with the addition of concepts, so that the complexity of the representation does not scale at the order of n\hat{ }2 as one adds concepts, but instead, it scales as Order(n). Accordingly, instead of having one concept dimension per node, in this new paradigm according to embodiments, a concept representation may be distributed across a fixed number of storage elements/fixed set of meta-nodes/fixed set of meta-semantic nodes (MSNs). The same fixed set of MSNs may, according to embodiments, in turn be used to define respective standard format basis vectors to represent respective concepts to be stored as part of the DKG. Therefore, the concept, as embodied in a vector as part of the DKG, may be reflected in different ways based on dimensions chosen to reflect the concept. Each pattern of numbers across the MSNs may be associated with a unique semantic concept (i.e. any information, such as clusters of information, that may be stored in a human brain, including, but not limited to information related to: people, places, things, emotions, space, time, benefit, and harm, etc.). Each pattern of numbers may in addition define and be represented, according to an embodiment, as a vector of parameters, such as numbers, symbols, or functions, where each element of the vector represents the individual level of activity of one of the fixed number of MSNs. In this way, each semantic concept, tagged with its meta-node's representative distributed activity vector (set of parameters that define the semantic concept) can be embedded in a continuous vector space. “Continuous” as used herein is used in the mathematical sense of a continuous function that is smooth and differentiable, as opposed to a discrete, with discontinuities or point like vertices where there is no derivative.

New Capability of Multi-Sensory and Data Modality Fusion

Because, according to some embodiments, any semantic concept may be represented, tagged, and embedded in a continuous vector space of distributed representations involving MSNs, any type of data, even data from widely disparate data types and storage formats, may be represented in a single common framework where cross-data type/cross-modality computation, search, and analysis by a computing system becomes possible. Given that the DKG's modality of concept storage according to embodiments is largely similar to that of the human brain, a DKG according to embodiments advantageously enables the representation of, discrimination between, and unified synthesis of multiple information/data types. Such information/data types may span the range of information/data types, from information/data that is completely physically based, such as, for example, sensor data, to information/data that is completely abstract in its nature, such as data based on thoughts and emotions. Embodiments further advantageously support a tunably broad spectrum of varying gradations of physical/real versus abstract data in between the two extremes of completely physical and completely abstract information/data.

Embodiments advantageously enable any applications that demand or that would benefit from integration, fusion, and synthesis of multi-modal, or multi-sensory data to rely on having, for the first time, a unifying computational framework that can preserve important semantic information across data types. Use cases of such applications include, by way of example only, employing embodiments in the context of diverse healthcare biometric sensors, written medical records, autonomous vehicle navigation that fuses multiple sensors such as LIDAR, video and business logic, to name a few. With greater preservation and utilization of increased information content as applied to computation, inference, regression, etc., such applications would advantageously perform with improved accuracy, would be able to forecast regression farther into the future and with lower error rates.

Advantage in Scalability

In some embodiments, where the basis set of MSNs in a DKG are fixed in number, as new semantic concepts are added to the DKG, the complexity of the DKG as a whole only grows linearly with the number of added semantic concepts, instead of quadratically or even exponentially with the number of inter-node connections as with traditional KGs. Thus, some embodiments advantageously replace the prior art solution of binary connections stored in simple matrices, which solution scales with the square of the number of semantic nodes, with a linear vector tag for each node, which vector tag represents a position of the node representing a given semantic concept in the larger vector space defined by the DKG. Up until embodiments, the prior n\hat{ }2 order of computational scaling properties of traditional KGs has presented a critical limitation in terms of allowing the application of machine learning and Al techniques to only the simplest or most confined problem domains. General questions, or applications requiring the bridging of multiple problem domains, such as ethical and economic questions related to health biometrics and procedures, have, up until now, been computationally intractable using traditional KGs.

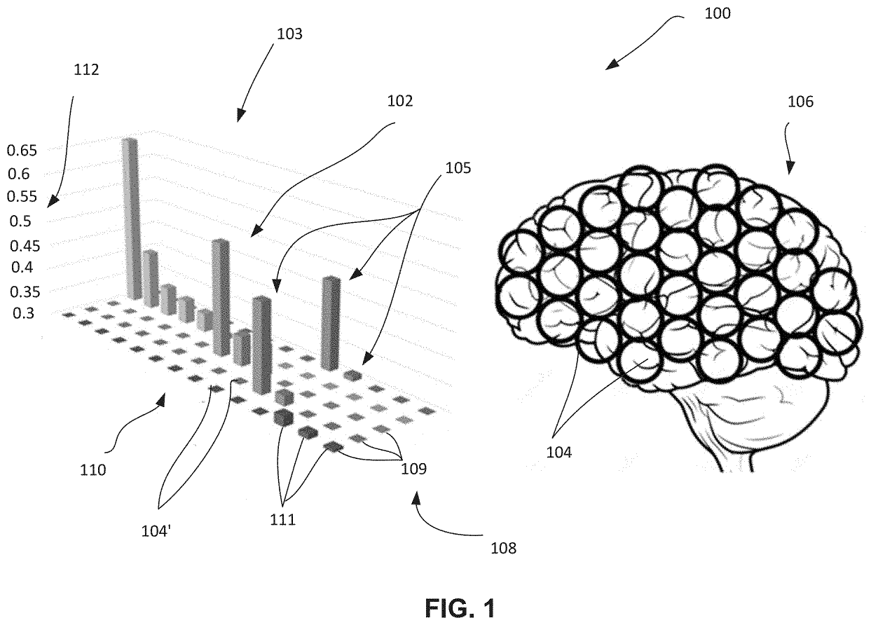

FIG. 1 shows a diagram 100 of a graph 103 and of an associated brain 106 regions of which have been mapped into the graph 103. In particular, graph 103 depicts activity levels 102 across 70 different partitioned volumes 104 of a brain 106 when the brain is thinking of one particular semantic concept, such as, for example “a tree.” Respective volumes 104 of brain 106 correspond to respective elements 104′ in graph 103, each element as shown corresponding to an intersection of concepts 109 and categories 111 (it is to be noted that lines are directed from the respective reference numerals 109 and 111 to only a few of the shown concepts in the figure) on two respective axes 108, 110, with levels 102 being reflected on a third axis 112 in the figure. Each bar within the bar graph 103 corresponds with a brain activity level 105 at a given element, with each element representing a dimension of the 70 dimensions shown, and each level representing the activity level (the numerical value for that given dimension) for that given element associated with the particular semantic concept: “tree.” In the shown embodiment of FIG. 1, by way of example, concepts on axis 108 may include, for example, respectively, 5 concepts, from bottom to top including feelings, actions, places, people and time, and concepts on axis 110 may include, for example, respectively, 14 categories, from left to right including person, communication, intellectual, social norms, social interaction, governance, settings, unenclosed, shelter, physical impact, change of location, high affective arousal, negative affect valence and emotion. When collected into a vector with seventy elements, this 70 dimensional vector (5 concepts times 12 concepts) may be used according to embodiments to tag the semantic concept, and position the semantic concept within the 70 dimensional vector space of a DKG.

How Semantic Concepts are Tagged & Organized with DKG Vectors

Referring still to FIG. 1, a new synthetic DKG architecture according to embodiments may be built upon a wide range of basis vectors to represent concepts that span human experiences. One particularly powerful instantiation was derived from neuroscience experiments which mapped a multiplicity of small roughly cubic centimeter sized brain volumes, such as volumes 104, partitioned into a set of 60-70 spherical volumes that cover the span of the cortex of the human brain. Each sub-volume of the brain 104, when active, has been found to represent one of a broad class of concepts, such as feelings and emotions, actions, moments in time (refer to axis 108 and concepts 109), as well as broad categories including places in space, physical movements, and even social interactions (refer to axis 110 and categories 111). However, in the aggregate, when all 70 volumes/dimensions resulting from an intersection of concepts and categories are considered, they define complex, varied, and very detailed distinctions with respect to how all of the brain regions may be relatively excited for each individual semantic concept, as well as exemplifying information in the topology of a DKG in terms of the relative activation strengths of simultaneously active meta-nodes, each set of relative activation strengths distinct for individual semantic concepts. Higher order matrices and/or tensors may also be used according to some embodiments to make more topologically complex semantic tags for different positions in the distributed vector space. For example, the array of activity levels for respective semantic concepts as embodied in nodes can be expressed as a 70 dimensional vector or a 5×14 array, as in the example of FIG. 1, and further, in addition to simple scalar variables, complex functions and virtual fields can be superimposed onto the vector space, or be configured to automatically operate on vector space parameters to create additional dimensions and subspaces. Since, in some embodiments, the number of MSNs is static, the field effect computations (i.e. functions) allow scaling in terms of Order(Constant) time to calculate as well: instead of having only arrays of stored vectors populated with numbers, embodiments provide for the imposition of a function that operates over the vector space/domain. For example, if one were to define an energy function in terms of f(x,y) where f(x,y)=x\hat{ }2+y\hat{ }2, the vector space is subjected to a quadratic function centered on the x, y, dimensional zero. According to another embodiment, a dimension in the vector space may be subjected to a function and store the results thereof by taking inputs from values in other dimensions.

Similar Semantic Concepts are Close to Each Other in the DKG Vector Space

A similarity or dissimilarity of semantic concepts according to embodiments is related to their distance with respect to one another as measured within the 70 dimensional space, with similar semantic concepts having a shorter distance with respect to one another.

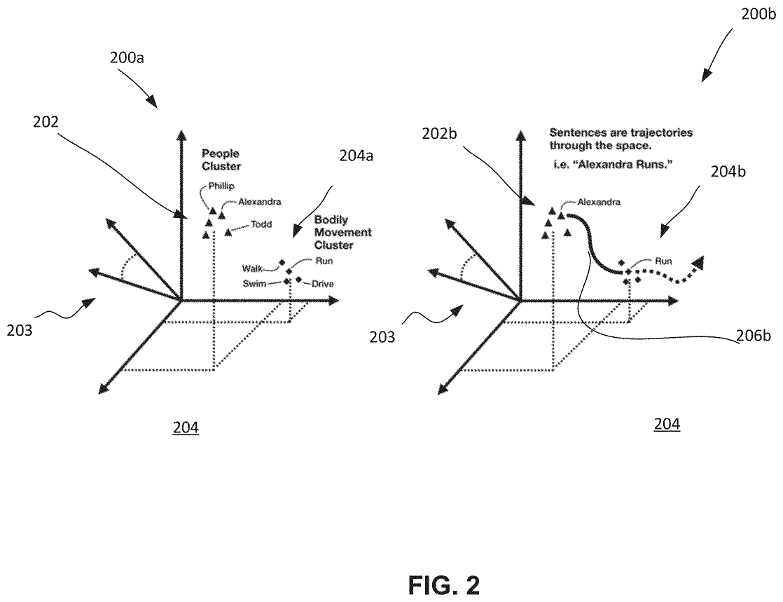

In this regard, reference is made to FIG. 2, which shows 90 plus dimensional vector spaces 200a and 200b with clustered semantic concepts/clusters 202a and 204a for vector space 200a, and 202b and 204b for vector space 200b, where similarity between various semantic concepts may be measured by virtue of their relative proximity. For example, semantic concepts associated with the names Phillip, Alexandra and Todd in FIG. 2 form a cluster 202a and 202b, and semantic concepts associated with physical movement including running, walking, driving and swimming form a cluster 204a and 204b, respectively, in vector spaces 200a and 200b. The dependency of similarity of semantic concepts on distance therebetween in the 70 dimensional space of a DKG according to embodiments and as shown in FIG. 2 is another distinction between embodiments and traditional knowledge graphs, which show similarity simply through connection, typically using a single bit of digital information. However, according to some embodiments, a wide range of distance functions may be used across manifolds and subspaces to further define a degree of similarity/dissimilarity between semantic concepts by embedding substantial complexity with respect to the data based on distance, on manifold shapes and on paths/trajectories between two semantic concepts. As used herein, a “subspace” refers to local volumes of the 70 dimensional vector space that are subsets of the whole space, and that include sub-space manifolds, surfaces, lower dimensional projections and paths/trajectories through the space, and represents collections of similar concepts. Concepts that are more closely related lie closer together in the vector space. The topology of the space and the manifolds represent relationships and dependence between nodes. Nodes, regions, and manifolds or subspaces can have attached semantic tags.

In FIG. 2, some of the dimensions of the 90 plus dimensional vector are represented schematically by way of axis arrows 203 which together serve to define the vector space. Each of the axes 203 represent an element on a graph such as graph 103 of FIG. 1, except that graph 103 of FIG. 1 illustrates 70 elements instead of 90+ element.

Referring still to FIG. 2, a DKG according to embodiments may be used to store information not only on semantic concepts, such as “tree” as shown in the graph of FIG. 1, but also on sentences, as suggested in semantic vector space 200b. According to one embodiment, sentences may be represented by trajectories through a semantic vector space. Thus, the sentence “Alexandra runs” may be stored in a DKG according to one embodiment with both MSNs relating to “Alexandra” and “Run,” respectively, tagged with information on trajectory 206b regarding the trajectory from the MSN representing “Alexandra” to the MSN representing “Run” in the semantic vector space.

Subsets of the larger vector space can also be used to focus the data storage and utilization in computation for more limited problem domains, where the dimensions not relevant to a particular problem or class of problems are simply omitted for that application. Therefore, a DKG architecture of embodiments is suitable for a wide range of computational challenges, from limited resource constrained edge devices like watches and mobile phones, all the way through the next generations of Al systems looking to integrate global-scale knowledge stores to approach General Artificial Intelligence (GAI) challenges.

Decomposition of Semantic Concepts into Assemblages of Related Supporting Parameters

An aspect of a DKG Architecture according to embodiments is that, by tagging a semantic concept with its vector in the continuous vector-space, such as the 70 dimensional vector space suggested in FIG. 1, or such as the 90+ dimensional vector space of FIG. 2, the DKG Architecture replaces a simple variable, say a number parameter that describes the level of “happiness” for example, with greatly enhanced information that relates the semantic concept of happiness to all the other semantic concepts that influence it. For example, other semantic concepts that are closer to, and influence “happiness,” such as the semantic concept of particular people's names, will be closer in the vector space to the happiness semantic concept than those less emotionally appealing. The above feature affords significantly enhanced information across the stored knowledge graphs above and beyond the existing solutions on simple parameters.

Representing Complex Abstract Anthropomorphic Semantic Concepts

In traditional knowledge graphs, the single concept dimension per node representation fails to capture critical nuances and detail of what influenced or was related to, or even what composed a semantic foundation for any one abstraction including but not limited to: emotions, good/bad, harm/benefit, fear, friend, enemy, concern, reward, religion, self, other, society, etc. However, with a DKG, according to embodiments, much more of the relational and foundational complexity is intrinsically stored with a semantic node by virtue of its position in the continuous vector space which represents its relation to the 70 different MSN concepts that form the basis of that space, as well as, notably, by virtue of distance as evaluated with respect to nearby concepts, and by virtue of how the semantic nodes are interconnected by both the local manifolds and the dynamics of the temporal memories that link nodes in likely trajectories. With this enhanced information intrinsic to the new knowledge store, synthetic computations on difficult abstractions may much more closely approach human behavior and performance.

Representing Physical Space in the DKG

The DKG according to embodiments is also a perfect storage mechanism to reflect how spatial information is stored in the human brain to allow human-like spatial navigation and control capabilities in synthetic software and robotic systems. If an application demands spatial computation, additional dimensions may be added to the continuous vector space for each necessary spatial degree of freedom, so that every semantic concept or sensor reading is positioned in the space according to where in space that measurement was encountered. A range of coding strategies are possible and can be tuned to suit specific applications, such as applications involving linear scaled latitude and longitude and altitude for navigation, or building coordinate codes for hospital sensor readings, or allocentric polar coordinates for local autonomous robotic or vehicle control and grasping or operation.

Explicitly Representing Time in the Distributed Knowledge Graph

Traditional neural network architectures represent time as having been engineered out of static network representations that analyze system states in discrete clocked moments of time, or in the case of recurrent or Long Short-Term Memory (LSTM) type networks, embed time as implicit in the functional dynamics of how one state evolves following the dynamical equations from one current state to a subsequent one. In contrast to those traditional neural computation strategies which treat time as either engineered away, or implicit in the memory dynamics, new DKG architectures according to embodiments allow for the explicit recording of a time of receipt and recording of a concept or bit of information, again, simply by adding additional dimensions for a timestamp to the continuous vector space. Again, a wide range of coding strategies are possible, from linear lunar calendar, to event tagged systems. Linear and log scales, and even non-uniform time scales which compress sparse regions and apply higher dynamic ranges to intervals of frequent data logging are possible according to embodiments. Cyclical time recording dimensions may, according to some embodiments, also be used to capture regular periodic behavior, such as daily, weekly, annual calendar timing. The addition of temporal information tags for stored data element offers an additional dimension of data useful for separating closely clustered information in the vector space. By analogy, people are better at recognizing faces in the places and at the typical times where they have seen those faces before.

Latent Dimensions, Renormalization, and other Newly Accessible Numerical Tools

Because the vector space of the DKG is continuous, a wide range of tools from physical science may be applied therein in order to allow a further honing of the representation of a semantic concept. For example, the data may even include data relating to general knowledge and/or abstract concept analysis. According to embodiments, operations widely used according to the prior art to tease out details and nuances from complex data, using with unwary directed binary links (which operations may be necessary in the context of a one-node-per context framework) are obviated. Embodiments advantageously apply varying types, ranges and amounts of data to DKGs. A tool according to embodiments is the ability to renormalize/reconfigure regions of a vector space to better separate/discriminate between densely related concepts, or to compress/condense sparse regions of the vector space. Another tool is based in the ability to add extra latent dimensions to the space (such as “energy” or for “trajectory density” to add degrees of freedom that would enhance distinct signal separability. By “energy,” what is meant herein is a designation of a frequency of traversal of a given dimension, such as a trajectory, time, space, etc., as the vector space is being built. Beyond the above tools, for the most part, all of the tools of physics and statistics may be directly applied to general knowledge formerly trapped by limited discrete representations.

Mechanism #1 for Short-Term Temporal Dynamics & Learning: Local Fields and Energy Dimensions

Additional dimensions may be added to the vector space according to embodiments to track additional parameters useful for learning, storage, efficient operation, or improvement in accuracy. Reference is again made to FIG. 2. According to some embodiments, sequences of thoughts and actions (such as spoken or heard sentences, or sequences of images and other data from autonomous vehicle sensors) that describe or operate on objects or concepts are represented computationally as trajectories of thought or sentences, and traverse the manifold from one concept to another, such as, for example, as represented by trajectory 206b. The paths of sequences of words in thought or speech may be tracked and logged according to some embodiments over vast volumes of experience and data recording. As with traditional machine learning technology, vast data sets including, but not limited to written text, spoken words, video images and data from car sensors, electronic health records of all data types, can all be presented to, and stored within a DKG according to some embodiments.

The learning process according to embodiments may use any of a broad class of algorithms which parameterize, store and adaptively learn from information on the trajectory of each semantic concept, including information of how and in which order in time each semantic concept is read in the context of each word and each sentence (for example, each image in a video may be presented in turn), to create a historical record of traffic, which historical record of traffic traces paths through the vector space that, trip over trip, describes a cumulative map, almost like leaving bread crumbs in the manner of spelunkers who track their escape from a cave. The result is that with every extra sentence or video sequence trajectory, another layer of digital crumbs (or consider it accumulated potential energy, to be relatable to gradient descent algorithms in physics and machine learning) is stored/left behind to slowly accumulate as learning progresses with every trial.

The above algorithm results in a potential map across the vector space, on which any gradient descent or field mapping, and trajectory analysis software can be applied to generate least time, minimum energy type paths, as well as most likely next steps in a trajectory (or even generate an ordered set of most likely next semantic concepts on the current path.).

After a learning epoch, the overall dimensions for energy in a vector space can be visualized as an accumulated surface level of “energy” where the least-to-most likely paths through the space between two semantic concepts appear as troughs and valleys, respectively. These surfaces can be analyzed using any typical field mapping and path planning algorithm (such as, by way of example only, gradient descent, resistive or diffusive network analysis, exhaustive search, or Deep Learning), to discover a broad range of computationally useful information including information to help answer the following questions:
1. What is the most efficient and shortest path to relate to respective ones of different concepts?
2. What other semantic concepts might be near a current/considered path, and information-equivalent? i.e. solving the similarity problem in a scalable way.
3. How dense/important are the trajectories through a particular semantic concept?
4. After traversing the DKG in a trajectory through training sets of example specific semantic concepts, given the current trajectory, what are the most likely next concepts, or sensor readings, or experiences to expect?
5. Given a current state/location and velocity in the DKG vector space, what were the most likely antecedents to the current state? By “velocity,” what is meant is the speed at which a trajectory traverses the vector space in moving from one input of a semantic concept to the next. Given that the vector space corresponds to a continuous space, one can measure position, and change in position in dimension x, and with time, one can then calculate dx/dt=velocity.

Sample Energy Field Based Learning and Operation Algorithm

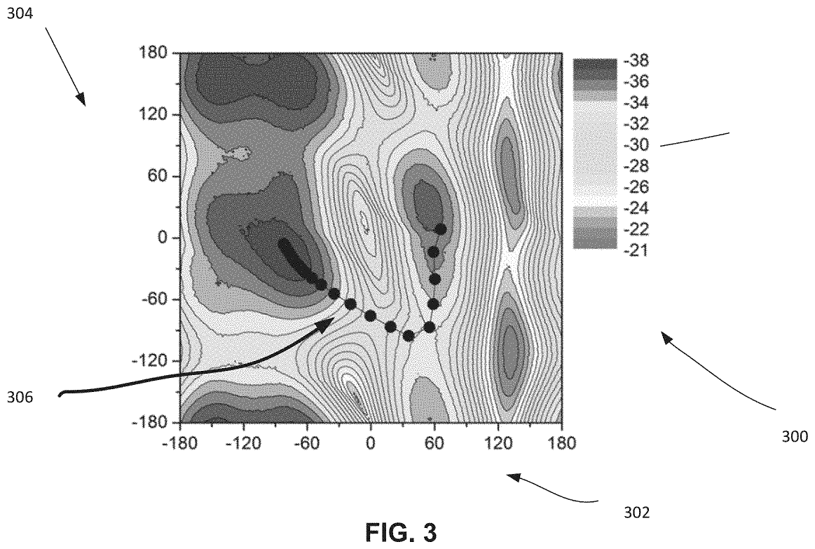

Reference is now made to FIG. 3, which shows a graph 300 of a sample energy field for semantic concepts and trajectories according to some embodiments. In FIG. 3, the horizontal and vertical axes 302 and 304 depict two dimensions in a multidimensional DKG vector space. In the shown 2D rendition of the DKG, the darker regions correspond to the various nodes represented in the DKG by way of respective vectors. Graph 300 may be generated according to one embodiment by using the below in order to generate the energy field, which may be established by achieving training based on the sets of semantic concepts:
1. for every string of semantic concepts in a sentence or in a sequence of sensory experiences to be recorded:
   1. for the first semantic concept in the string to be ingested into the knowledge graph, assign its proper multivector (such as 70-vector) tag as defined in an MRI experimental measures, which tag is a measure of the various levels of response for that particular semantic concept at respective elements/dimensions of the multivector space, such as levels 102 of FIG. 1 in graph 103. Thereafter, add one unit of energy to the local energy field variable (local to the MSN representing the semantic concept) at the region of the vector space. Note that the radius over which a parameter value, such as energy, is added to a given field of that parameter value may be tuned according to some embodiments;
   2. for each subsequent semantic concept that has been read and vector tagged as explained in 1. above, compute a line/trajectory, such as line/trajectory 306, from the prior semantic concept in the string to the current one, and distribute/assign one unit of energy along the path of that line/trajectory; and
   3. repeat for each semantic concept in the sentence or experience string; and
2. repeat for every sentence or experience string.

An Operation According to Some Embodiments may Include:
3. supplying an initial or an incomplete string (with string referring to a string of semantic concepts of a vector space, the semantic concepts in a sentence or in any another format to form the string);
4. using a gradient ascent mechanism to perform a regression forward in time to estimate a most likely next point/node corresponding to one or more first semantic concepts in the vector space;
5. using a gradient ascent backward in time to estimate most likely antecedent point/node corresponding to one or more second semantic concepts in the vector space;
6. using relaxation methods on the surface, such as, for example, Hopfield, diffusion, recurrent estimation, or the like for any incomplete strings to complete missing points. For example, using the concept of the Hoppfield associative memory, the observation of an image through fog may lead to a decision that the image corresponds to head and fog lights, without more information. The relaxation method takes the existing input, and uses the intrinsic dynamics of how the inputs nodes/points are all interconnected to one another (the connections of which have been programmed through repeated exposure to complete cars) to iteratively fill in the missing data to lead to a decision that the image corresponds to a car that would go with that set of imaged headlights, completing the picture, the missing point.
7. using relaxation methods in numerical mathematics to propagate an initial activity of two distinct points/nodes across the energy surface to determine shortest path/trajectory between the two distinct points/nodes, accumulated energy (i.e. or how close is the relationship) between two semantic concept nodes in the vector space; and/or
8. inputting multiple semantic data outputs from a prior stage of neural networks into the DKG to synthesize them and couple them with additional semantic data and written and other business logic to perform and optimize sensory fusion.

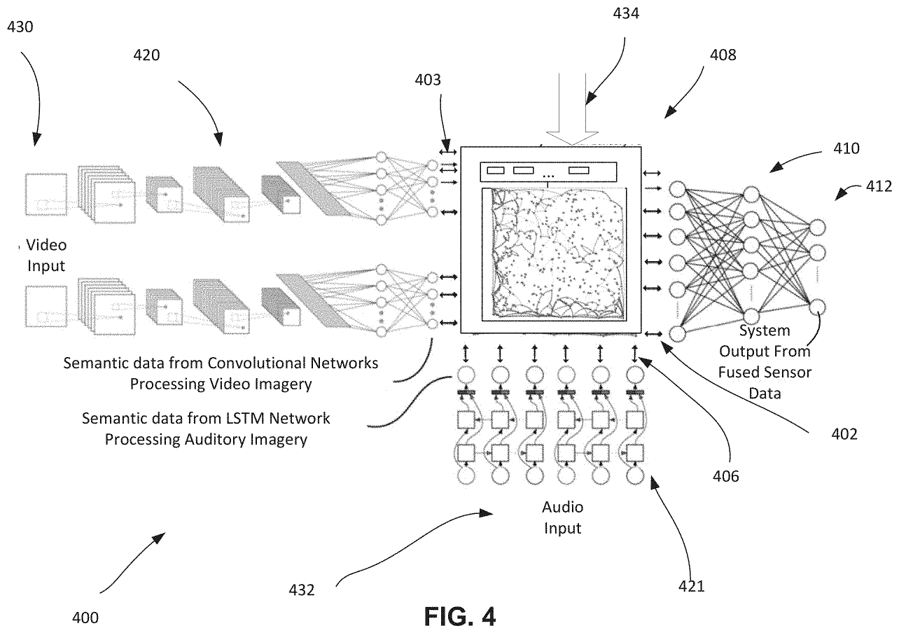

With respect to item 8 immediately above, reference is now made to FIG. 4, which depicts a system 400 including a device 408 including one or more processors and a memory, the device 408 to receive various types of data inputs for synthesis of various data types therein. The memory is to store a DKG according to some embodiments. Device 408 is adapted to perform a set of parameterizations of semantic concepts, and generate a training model from those concepts, the training model corresponding to a data structure associated with a DKG according to some embodiments. In the shown embodiment of FIG. 4, the semantic concepts correspond to semantic data 403 from neural network-based computing system 420 that are to process video imagery, and further to semantic data 406 from neural network-based computing system 421 that are to process audio data.

Neural networks to be used for leaning and for making predictive analysis on the training model generated from the learning according to embodiments may include any neural networks, such as, for example convolutional neural networks or recurrent neural networks to name a few. The neural network-based computing systems 420 and 421 of FIG. 4 respectively receive video data 430 and audio data 432 as inputs thereto for training and subsequent computation/processing/analysis.

According to an embodiment, each parameterization of the set includes: (1) receiving existing data representing semantic concepts (where, in the shown example of FIG. 4, the existing data corresponds to empirical data 434 and to video data 403 from an output of a neural network-based computing system 420 that processes video input, and of audio data 406 from an output of a neural network-based computing system 421 that processes audio input); (2) generating a data structure using the processing circuitry, the data structure corresponding to a Distributed Knowledge Graph (DKG) defined by a plurality of nodes each representing a respective one of a plurality of unique semantic concepts (in the shown case of FIG. 4, for example, semantic concepts corresponding to both video data and audio data, including a fusion of both types of data from respective data domains (e.g. video and audio)—that is, a combination of the dimensions associated with each type of data to define respective nodes in the DKG), the plurality of unique semantic concepts being based at least in part on the existing data (that is, for example, on data 434, 403 and 406), each of the nodes represented by a characteristic distributed pattern of activity levels for respective meta-semantic nodes (MSNs) (as shown for example in FIG. 1), the MSNs for said each of the nodes defining a standard basis vector to designate a semantic concept, wherein standard basis vectors for respective ones of the nodes together define a continuous vector space of the DKG; and (3) storing the data structure in the memory circuitry of device 408. In addition, according to some embodiments, in response to a determination that an error rate from a processing of the data set by the neural network-based computing system is above a predetermined threshold (where a determination of a predetermined threshold according to embodiments is implementation based/based on application needs, with a lower threshold corresponding to instances where making an error would carry a higher degree of risk, such as, for example, errors associated with processing/interpreting/analyzing certain medical data), an embodiment includes performing a subsequent parameterization of the set. A repetition of the parameterization stage may involve, according to some embodiments, an outputting of data back into each of the neural network-based computing systems 420 and 421 from device 408 in order for those networks to perform learning algorithms on the thus outputted data before re-inputting the data, as existing data, back into the device 408 for further parameterization. An embodiment includes generating a training model corresponding to the data structure from a last one of the set of parameterizations, the training model to be used by the neural network, such as neural network-based computing systems 420 and 421, to process/perform a computational algorithm on/interpret/analyze/make inferences based on semantic data, such as, for example, by performing predictive analytics on a data set, performing classification based on the data set, or performing any other type of computation on the data set, to name a few examples. According to one embodiment, computer system may be deemed to include the neural networks 420/421.

As referred to herein, “input” and “output” in the context of system hardware designate one or more input and output interfaces, and “input data” and “output data” in the context of data designate data to be fed into a system by way of its input or accessed from a system by way of its output.

Video data inputs 403 may be generated by neural networks 420 adapted to process video imagery, such as, for example, in a known manner. Audio data inputs 406 may be generated by neural network 421 adapted to process auditory information, such as, for example, in a known manner. Data from the DKG memory store 408 is shown as being outputted at 402 into a neural network-based computing system 410. Neural network-based computing systems 420, 421 and 410 may, according to some embodiments, function in parallel to provide inferences in the form of output 412 regarding different dimensions or clusters of dimensions of the data stored within the DKG of device 408.

Where DKG represents a distributed knowledge store of nodes represented by multidimensional vectors, such as in the shown example of FIG. 4 by vectors that synthesize at least video and audio information, a DKG according embodiments advantageously permits: (1) more meaningful learning to take place within respective neural network-based computing systems by virtue of more meaningful data sets from the DKG memory store, and (2) data output from a neural network, such as neural network-based computing system 410, that operates based on fused/converged data, with all of the advantages with respect to the use of such data, such as, for example: (a) much faster processing time by virtue of the ability to access and use multiple dimensions of data for a given node simultaneously to operate neural network-based computing systems in parallel (such as neural network-based computing systems 420 and 421 of FIG. 4) with one another to process respective types of data, such as respective dimensions of data simultaneously; and (b) as noted previously, the ability to afford a linear scaling with respect to data storage complexity as opposed to the quadratic or even exponential scaling expected with the one concept dimension per node approach of the prior art to advantageously allow a more efficient use of computer memory space, allowing a given memory space to be used to store more data and more relationships between the data than a given memory space to be used to store data structures of the prior art to be used in neural networks and (c) the ability to afford a linear scaling with respect to data storage complexity as opposed to the quadratic or even exponential scaling expected with the one concept dimension per node approach of the prior art to advantageously allow the use of computational tools configured to implement and process multi-dimensional data, in this manner speeding up the implementing of data structures for training models to be used by neural network-based computing systems for interpretation/processing, such as for performing predictive analytics, for classification, or for other computations, and in this way also leading to the accuracy and automation of data processing where, instead of a manual process of integrating data from different domains, integrated data from various domains can be accessed by respective neural networks in parallel and learning with respect to such integrated data may take place by way of machine learning instead of requiring human interference to integrate output data of the respective neural network-based computing systems such as for processing/interpreting data sets.

An embodiment to fuse data, as shown by way of example in FIG. 4, advantageously allows the implementation of higher level neural network systems that are effectively integrations of respective neural network-based computing systems, with modular systems of neural network-based computing systems that are specialized to specific computational tasks unique to their individual sensor modality and data types, and yet, all are synthesized through the central switching station represented by the DKG.

Mechanism #2 for Long-Term and Higher-Order Temporal Dynamics & Learning: A Cerebellar Predictive Co-Processor

Embodiments relating to the local field learning mechanism above are suitable for helping to navigate through the vector space and compute with nearby similar semantic concepts that are neighbors within a vector space at a close range, with the definition of close being implementation specific. To navigate larger jumps and perform meaningful computations between more disparate concepts that are more distant across the vector space (again, with the definition of distant being implementation specific), some embodiments provide mechanisms that incorporate more global connections between semantic nodes to manage larger leaps and transitions in logic as well as the combination of a wide range of differing data types and concepts.

To be useful in the real world however, embodiments may also rely on an intrinsic notion of time, embodied as data, that can reference and include past learned experience, understand its current state, and use both learned information about stored past states combined with sensor derived information on the system's current state to predict and anticipate future states.

Combining these two fundamental requirements of a DKG incorporating information on the intrinsic notion of time into the specification for a synthetic system makes it possible to recapitulate the functioning of the human cerebellum. A Synthetic Predictive Co-processor (SPC) according to embodiments, like the human cerebellum, is connected to the entirety of the rest of its cortex, in the synthetic case, to each of the nodes of the DKG, through which connections it monitors processing throughout the brain, and generates predictions as to what state each part of the brain is expected to be in across a range of future time-scales, and supplies those global predictions as additional inputs for the DKG. As with the human brain, the addition of expectation, or in the synthetic system, having a prior and posterior probability prediction together improve system performance.

In a sense then, the cerebellar SPC becomes a high volume store of sequences or trajectories through the vector space, which can track multiple hops between distant concepts that are unrelated other than that they are presented through a sentence or string of experiences. Average sentences require 2-5 concepts, so predictive coprocessors focusing on natural language processing can be scoped to store and record field effects across the vector space for 5-step sequences. Longer sequences, such as chains of medical records, vital signs, and test measurement results will require longer sequence memories.

Another instantiation of the SPC according to some embodiments may be based on Markov type models, but extended from the discrete space of transition probabilities to the continuous vector space of trajectories within a DKG, given prior points in the trajectory. Different applications may require different order predicates, or number of prior points according to some embodiments. The larger the number of predicate points, the higher the storage requirements are, and the greater the diversity of predictive information.

The above new architectural approach has the added feature that continuous mathematical tools can be applied to the vector space tags, and discrete graph tools can be applied to the semantic nodes to determine typical graph statistics (degree/property histogram, vertex correlations, average shortest distance, etc.), centrality measures, standard topological algorithms (isomorphism, minimum spanning tree, connected components, dominator tree, maximum flow, etc.)

The Central Integration Component to Build More Complete Brains

For a synthetic system, we can replicate the end-to-end capability according to some embodiments for the most part in any machine learning architecture, leveraging the fact that the DKG lies on a continuous vector space domain, and several key parameters lie as continuous functions on the space, such as the energy and error surfaces, and are therefore differentiable. This means that for the first time, all of the gradient descent (such as Backwards Error Propagation) learning strategies, and all the dynamical systems based relaxation techniques, such as Hopfield and recurrent type networks, to tune weights and connectivities, and parameters of networked computing elements, as in Deep Learning, and Convolutional Network systems, can be applied to knowledge graph learning and tuning. This foundational capability was not possible with traditional knowledge graphs based on discrete nodes with digital connections, where there was no gradient or surface function that was differentiator in order to determine error calculations.

Because the DKG may, according to an embodiment, have the same properties of continuity and differentiability as Deep Learning and Convolutional Networks, for the first time, any type of neural architecture can be seamlessly integrated together with a DKG, and errors and training signals propagated throughout the hierarchical assemblage.

In this sense, the DKG becomes the coupling mechanism by which previously incompatible neural network type computing engines can all be interconnected to synthesize broader information contexts across multiple application domains. They becomes the central point of integration, a larger network of neural networks to make more complete synthetic brains capable of multi-sensory fusion and inference across broader and more complex domains than was ever possible before with artificial systems.

Information Encoding Strategies

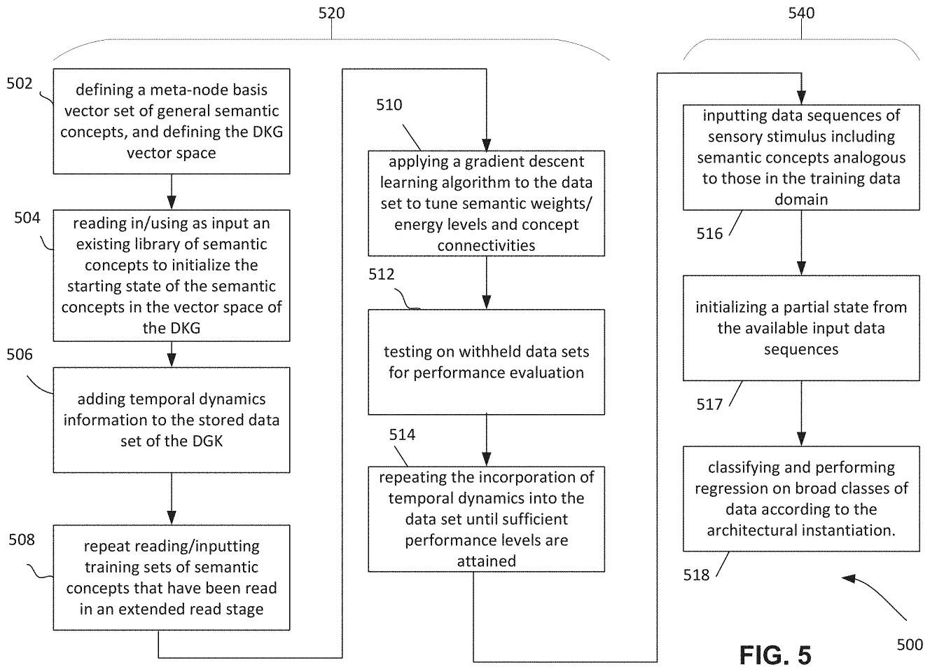

Principles of operation of some embodiments are provided below, reflecting some embodiments of information encoding strategies, as illustrated by way of example in FIG. 5. The process 500 of FIG. 5 may include an initialization and learning/training stage 520, and a generation operation stage 540.

Initialization and learning stage 520 may first include at operation 502, defining a meta-node basis vector set of general semantic concepts, and defining the DKG vector space based on the same. In this respect, reference is made to the 70 dimensional vector space suggested in FIG. 1, and the 90+ dimensional vector space of FIG. 2, which help to store vector tags to identify distinct semantic concepts. Thereafter, at operation 504, the initialization and learning stage 520 may include reading in/using as input an existing library of semantic concepts to initialize the starting state of the semantic concepts to position them in the vector space of the DKG. A strategy according to an embodiment may involve using one of the human spoken words+Functional Magnetic Resonance Imaging (FMRI) databases, where each word spoken to a subject can be tagged with the associated activity vector indicated by the brain FMRI readings. Different verbal corpora can be used to make semantic maps in the DKG for different application areas according to some embodiments. At operation 506, temporal dynamics information may be added to the stored information in the DGK, either after the reading/input stage noted above, or in parallel therewith. In the case of the latter, as once reads successive semantic concepts to be added to the DKG, it is possible to add the path tracking information or “breadcrumbs” to log most traveled/likely semantic trajectories through the vector space of the DKG. Other strategies to record and include temporal dynamics according to some embodiments may include: using Bayesian or Markov model type algorithms that encode and exploit probabilities of state changes, and/or training neural architectures that encode temporal dynamics on the vector space, such as recurrent neural networks or LSTMs. Thereafter, at operation 508, training sets of semantic concepts that have been read in are repeated in an extended read stage. In the process of training, sets of sequences of semantic concepts in the logical flow of an application may be repeated so that the system is trained over time to learn the most common sequences. After the repetition, a initialization and learning stage 520 according to some embodiments includes at operation 510 applying a gradient descent learning algorithm to tune semantic weights/energy levels and concept connectivities. Several applicable algorithms that are compatible with this new architecture include: a Naïve Bayes Classifier Algorithm, a K Means Clustering Algorithm, a Support Vector Machine Algorithm, an Apriori Algorithm, Linear Regression, Logistic Regression, Artificial Neural Networks, Random Forests, Decision Trees, Nearest Neighbors. According to an embodiment, the initialization and learning stage 520 may involve at operation 512 testing on withheld data sets for performance evaluation. According to an embodiment, a initialization and learning stage 520 may further include at operation 514 repeating the incorporation of temporal dynamics into the data set until sufficient performance levels are attained.

Referring still to FIG. 5, the generation operation stage 540, which begins after the initialization and training stage 520, includes at operation 516, inputting data sequences of sensory stimulus including semantic concepts analogous to those in the training data domain. At operation 517, stage 540 includes initializing a partial state from the available input data sequences, and at operation 518, stage 540 includes classifying and performing regression on broad classes of data according to the architectural instantiation.

Specific examples of particular instantiations and applications are provided below.

Embodiments may be used in the context of improved natural language processing. The latest NLP systems vectorize speech at the word and phoneme level as the atomic component from which the vectors and relational embedding and inference engines operate on to extract and encode grammars. However, the latter represent auditory elements, not elements that contain semantic information about the meaning of words. By using the DKG space, the atomic components of any single word are the individual MSN activity levels representing the all compositional meanings of the word, which in the aggregate hold massively more information about a concept than any phoneme. Deep Learning and LSTM type models may therefore be immediately enhanced if the data storage system were converted to the continuous vector space of the DKG architecture.

Embodiments may be used in the context of healthcare record data fusion for diagnostics, predictive analytics, and treatment planning. Modern electronic health records contain a wealth of data in text, image (X-ray, MRI, CAT-Scan) ECG, EEG, Sonograms, written records, DNA assays, blood tests, etc., each of which encodes information in different formats. Multiple solutions, each of which can individually reveal semantic information from single modalities, like a deep learning network that can diagnose flu from chest x-ray images, can be integrated directly with the DKG into a single unified system that makes the best use of all the collected data.

Embodiments may be used in the context of multi-factor individual identification and authentication which seamlessly integrates biometric vital sign sensing with facial recognition and voice print speech analysis. Such use cases may afford much higher security than any separate systems.

Embodiments may be used in the context of autonomous driving systems that can better synthesize all the disparate sensor readings. Including LIDAR, visual sensors, onboard and remote telematics.

Embodiments may be used in the context of educational and training systems that integrate student performance and error information as well as disparate lesson content relations and connectivity to generate optimal learning paths and content discovery.

Embodiments may be used in the context of smart City infrastructure optimization, planning, and operation systems that integrate and synthesize broad classes of city sensor information on traffic, moving vehicle, pedestrian and bike trajectory tracking and estimation to enhance vehicle autonomy and safety.

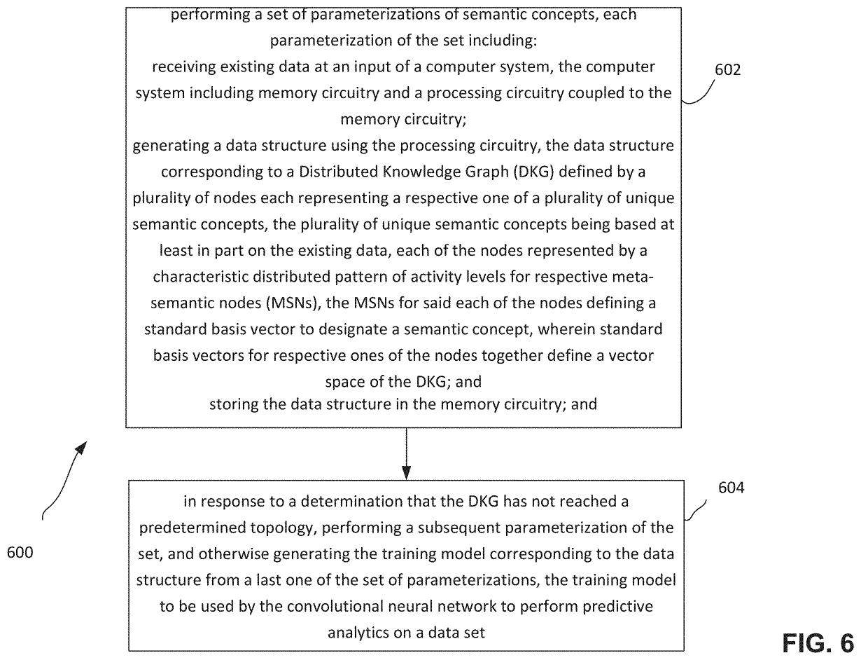

FIG. 6 shows a process 600 according to an embodiment. Process 600 includes, at operation 602, performing a set of parameterizations of the plurality of semantic concepts, each parameterization of the set including: receiving existing data on the plurality of semantic concepts at an input of a computer system, the computer system including memory circuitry and a processing circuitry coupled to the memory circuitry; generating a data structure using the processing circuitry, the data structure corresponding to a Distributed Knowledge Graph (DKG) defined by a plurality of nodes each representing a respective one of the plurality of semantic concepts, the plurality of semantic concepts being based at least in part on the existing data, each of the nodes represented by a characteristic distributed pattern of activity levels for respective meta-semantic nodes (MSNs), the MSNs for said each of the nodes defining a standard basis vector to designate a semantic concept, wherein standard basis vectors for respective ones of the nodes together define a continuous vector space of the DKG; and storing the data structure in the memory circuitry; and at operation 604; and at operation 604, in response to a determination that an error rate from a processing of the data set by the neural network-based computing system is above a predetermined threshold, performing a subsequent parameterization of the set, and otherwise generating a training model corresponding to the data structure from a last one of the set of parameterizations, the training model to be used by the neural network-based computing system to process further data sets

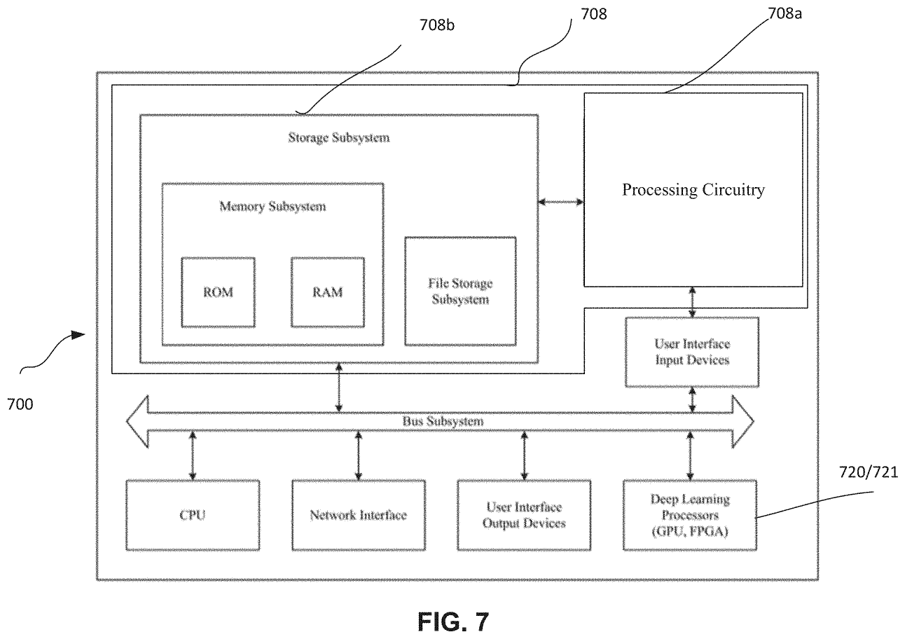

FIG. 7 is a simplified block diagram of a computing platform including a computer system that can be used to implement the technology disclosed. Computer system 700 as shown includes at least one processing circuitry 708a that communicates with a number of peripheral devices via bus subsystem. These peripheral devices can include a storage subsystem 708b including, for example, one or more memory circuitries including, for example, memory devices and a file storage subsystem. All or parts of the processing circuitry 708a and all or parts of the storage subsystem 708b may correspond the processing circuitry and memory described in the context of FIG. 4, and computer system 708 may in addition correspond to computer system 408 of FIG. 4, by way of example.

Peripheral devices may further include user interface input devices, user interface output devices, and a network interface subsystem. The input and output devices allow user interaction with computer system. Network interface subsystem provides an interface to outside networks, including an interface to corresponding interface devices in other computer systems.

In one implementation, the neural network-based computing systems according to some embodiments are communicably linked to the storage subsystem and user interface input devices.

User interface input devices can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system.

User interface output devices can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system to the user or to another machine or computer system.

Storage subsystem may store programming and data constructs that provide the functionality of some or all of the methods described herein. These software modules are generally executed by processor alone or in combination with other processors.

The one or more memory circuitries used in the storage subsystem can include a number of memories including a main random access memory (RAM) for storage of instructions and data during program execution and a read only memory (ROM) in which fixed instructions are stored. A file storage subsystem can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem in the storage subsystem, or in other machines accessible by the processing circuitry. The one or more memory circuitries are to store a DKG according to some embodiments.

Bus subsystem provides a mechanism for letting the various components and subsystems of computer system communicate with each other as intended. Although bus subsystem is shown schematically as a single bus, alternative implementations of the bus subsystem can use multiple busses.

Computer system itself can be of varying types including a personal computer, a portable computer, a workstation, a computer terminal, a network computer, a television, a mainframe, a server farm, a widely-distributed set of loosely networked computers, or any other data processing system or user device. Due in part to the ever-changing nature of computers and networks, the description of computer system depicted in FIG. 7 is intended only as a specific example for purposes of illustrating the technology disclosed. Many other configurations of computer system are possible having more or less components than the computer system depicted herein.

The deep learning processors 720/721 can include GPUs, FPGAs, any hardware adapted to perform the computations described herein, or any customized hardware that can optimize the performance of computations as described herein, and can be hosted by a deep learning cloud platforms such as Google Cloud Platform, Xilinx, and Cirrascale. The deep learning processors may include parallel neural network-based computing systems as described above, for example in the context of FIG. 4, such as neural network-based computing systems 420/421.

Examples of deep learning processors include Google's Tensor Processing Unit (TPU), rackmount solutions like GX4 Rackmount Series, GX8 Rackmount Series, NVIDIA DGX-1, Microsoft' Stratix V FPGA, Graphcore's Intelligent Processor Unit (IPU), Qualcomm's Zeroth platform with Snapdragon processors, NVIDIA's Volta, NVIDIA's DRIVE PX, NVIDIA's JETSON TX1/TX2 MODULE, Intel's Nirvana, Movidius VPU, Fujitsu DPI, ARM's DynamiclQ, IBM TrueNorth, and others.

The components of FIG. 7 may be used in the context of any of the embodiments described herein.

Data Representations of Time (Rate of Flow, Past, Present, and Future) for Artificial Intelligence Systems

Current machine learning systems use clocked von Neumann architectures that do not explicitly encode time, but rather engineer away troublesome time dependencies that might lead to instability through feedback. Computations are represented as spatial patterns of digital bits at discrete fixed points in time, all of which are changed in lockstep synchrony with global system clocks.

While the latest Recurrent Neural Network (RNN) architectures (e.g., long short-term memory (LSTM) architectures) introduce some elements that preserve or sample some historical state to be used on current computations, this utilization of time history remains implicit in the recurrent architectures, but it is not represented in the data stored as bits in the computer memory.

The problem with this technique is that there is no intrinsic representation of when something has happened in the past, or what might be expected to happen in the future, in such a way that external computational units can interface with, and either make use of or influence the use of, the temporal information in modular computational systems. The temporal information is not independent of the computing architecture, and therefore it has fixed, low precision and cannot be read or written, or acted upon, in any direct computational algorithm. Another way of stating the limitation is that temporal aspects of recurrent and recurrent-type networks (e.g., LSTMs) are strongly bound and constrained in the architecture definition stage of system design, whereas human brains use time codes in a loose and late binding strategy where precision information on memory storage timing is stored part and parcel with the information being stored. For example, biological brain memory storage intrinsically encodes sequences of memories, which are each tagged with a corresponding time of storage.

Accordingly, this disclosure presents embodiments that leverage a broad class of architectural representations of temporal information to address how the timing of stored memories can be incorporated alongside the stored data across broad classes of general computing systems, including conventional and connectionist architectures, to improve general performance.

Explicitly Representing Time in a Distributed Knowledge Graph

Traditional computing and neural network architectures represent time as having been engineered out of static network representations that analyze system states in discrete clocked moments of time, or in the case of recurrent or LSTM type networks, embed time as implicit in the functional dynamics of how one state evolves following the dynamical equations from one current state to a subsequent state. In contrast to those traditional neural computation strategies which treat time as either engineered away, or implicit in the memory dynamics, the data representation architecture presented in this disclosure allows for the explicit recording of a timestamp of when a concept or bit of information was received and recorded in memory. This can be in a standard clocked timestamp format for traditional digital computing architectures, or in the case of neural computing paradigms, can be introduced into distributed connectionist architectures by simply adding additional dimensions for a timestamp to the continuous vector space.

The critical purpose of this feature is to add an additional dimension to any data set whose datapoints might otherwise overlap and/or suffer from added noise, as classification and regression type solutions perform poorly in the face of inseparable or otherwise difficult to discriminate datapoints, such as those lost in noise. By introducing an explicit time variable as part of the data set, the moment in time when a particular data point (e.g., a sensation or internal state) is recorded becomes accessible as a component and independent or dependent variable for computation purposes. The addition of temporal information tags for every stored data element offers an additional dimension of data useful for separating closely clustered information that, through overlap and noise, confounds classification and regression strategies. By analogy, people are better at recognizing faces in the places and at the typical times where they have seen those faces before. In many types of classification and regression computing challenges, temporal information is a principle component of animal and machine behavior as well as progressions of natural events in the physical world. As such, explicit information is critical for developing automated machine learning (ML) and artificial intelligence (Al) computing tools to interact with people and the natural environment.

By adding explicit temporal information in appropriate code representations, radical computing performance improvements are possible across a broad range of classification, regression, and general computing tasks.

A wide range of temporal coding strategies are possible, and this disclosure presents several of the most commonly applicable coding strategies for different classes of computing and recognition problems.

Linear Temporal Codes

The simplest temporal coding strategy involves a straight clocked timestamp using a universally synchronous clock, similar to how server and computing systems today store a millisecond-based timestamp with every log. Simply by explicitly adding such a timestamp to machine learning data sets, the performance of discrimination and regression techniques can be significantly improved.

Log Scale Temporal Codes

Many applications leverage data that spans a wide temporal range (e.g., consider machine logs that span multiple decades while requiring millisecond-level precision for individual timestamps). As a result, however, efficient classification and regression suffers a challenge in the dynamic range of number representations, which makes small timescale discrimination and regression between millisecond intervals difficult while also preserving long decade-scale epochs that are integral to a computation. In such cases, it is advantageous to incorporate a log scale representation, where the farther back in time you go, the larger the scale at that interval, while preserving computational dynamic range for denser, more recent events.

Variable Compressive Temporal Codes

Human brains have an even more complex temporal encoding strategy, which varies the encoding rate and precision depending on how emotionally engaging an experience is. Traumatic, exciting, and/or exhilarating experiences are recorded at much higher density and precision than dull, boring, and/or expected experiences. This disclosure applies a similar approach to synthetic systems by representing temporal dimensions as nonlinear manifolds in vector spaces that are not uniformly spaced. Any arbitrary function can be applied to the temporal dimension records to compress or decompress their coding and expression, so as to use more computational dynamic range where there is high information density, and less where the information to be encoded is sparse.

Periodic Temporal Codes

Cyclical and periodic time recording strategies are also useful to capture, characterize, identify, and predict regular periodic behavior, such as hourly, daily, weekly, and/or annual timing regularities, among other examples. For example, when developing machine learning systems to predict when a person is going to navigate to work, the absolute linear timestamp is less relevant than a periodic weekly calendar that more precisely isolates daily routines of the workweek and weekend, and a daily calendar which highlights regular commute time history. As another example, diurnal cycles are critical for hospice and other medical care tracking.

Temporal Code Representation Strategies

There are a broad range of possible temporal code representation strategies in both traditional von Neumann computing architectures as well as newer connectionist computing architectures that involve deep learning and convolutional neural networks (DNNs and CNNs), LSTM networks, recurrent networks, support vector machines (SVMs), and so forth.

Examples of possible temporal coding strategies include the following:
1. discrete digital timestamps;
2. continuous analog and/or floating point representations across finite intervals;
3. distributed neural representation of temporal codes;
4. representation across complex manifolds and subspaces of larger vector spaces; and
5. sparsified code representations.

Any and all of them are integral to, and improve the performance of, efficient machine learning and Al systems designed to interact with people and the natural world. As an example, an intelligent biometrics system could leverage these temporal data representations to recognize, classify, and predict patterns in biometric health data.

Data Representations of Physical Location for Artificial Intelligence Systems

Current machine learning systems are limited in memory performance relative to the human brain because they lack many aspects of the human brain that are central to the process of memory consolidation and disambiguating different experiences. In particular, one of the key elements of human memory disambiguation is the co-storage of the location where a particular memory was acquired.

Accordingly, the embodiments presented throughout this disclosure include a broad class of memory systems that automatically encode and incorporate spatial information and representations in parallel and integral with each memory acquired and stored by an Al system. This added degree of freedom offers a powerful additional mechanism to improve separation and disambiguation of noisy data that might otherwise be confused or misclassified.

These embodiments leverage information theory, software and hardware architectures and instantiations, and application area examples using both global and allocentric (viewer relative) location coordinate system strategies, as described further below.

Explicitly Representing Space and Position in Computations

Traditional computing and neural network architectures generally omit where and when a datapoint in a training or test set is sampled and/or otherwise added to the system operation. The physical provenance or location of a datapoint, however, is often useful information as to its accuracy or relevance to a broad range of computational tasks.

The critical purpose of adding spatial and position coding features is to add an additional dimension to any data set whose datapoints might otherwise overlap and/or suffer from added noise, as classification and regression type solutions perform poorly in the face of inseparable or otherwise difficult to discriminate datapoints, such as those lost in noise. By introducing explicit position variables as part of the data set, the location or position where a particular datapoint (e.g., a sensation or internal state) is recorded becomes accessible as a component and independent or dependent variable for computation purposes. The addition of spatial and position information tags for every stored datapoint or data element offers an additional dimension of data useful for separating closely clustered information that, through overlap and noise, confounds classification and regression strategies. By analogy, people are better at recognizing faces in the places where they have seen those faces before. In many types of classification and regression computing challenges, spatial and position information is a principle component of animal and machine behavior as well as progressions of natural events in the physical world. As such, explicit spatial and position information is critical for developing automated machine learning and Al computing tools to interact with people and the natural environment.

By adding explicit spatial and position information using appropriate code representations, radical computing performance improvements are possible across a broad range of classification, regression, and general computing tasks.

A wide range of spatial/position coding strategies are possible, and this disclosure presents several of the most commonly applicable coding strategies for different classes of computing and recognition problems.

Linear Spatial Codes

The simplest spatial coding strategy involves a straight clocked global positioning system (GPS) type location stamp, such as a universal latitude, longitude, and/or altitude localization stamp, which is added to every datapoint. Simply by explicitly adding such a position stamp to machine learning data sets, the performance of discrimination and regression techniques can be significantly improved.

Log Scale Spatial Codes

Many applications leverage data sets that span a wide spatial range (e.g., consider measuring astronomical variables with angstrom-level position accuracy to predict exoplanetary trajectories with centimeter-scale precision for individual data record stamps). As a result, however, efficient classification and regression suffers a challenge in the dynamic range of number representations for recorded positions, which makes small-scale discrimination and regression between angstrom intervals difficult while preserving long lightyear-scale epochs that are integral to a computation.

In such cases, it is advantageous to incorporate a log scale representation of recorded positions, where the farther away things (e.g., objects, events) are relative to a particular reference position (e.g., relative to a person), the larger the scale of the position stamps that are recorded at those intervals, while computational dynamic range is preserved for the position stamps of objects and events that are denser or closer in physical proximity.

As an example, things in close physical proximity to a particular person may have their positions recorded with a higher degree of granularity or precision than those that are farther away from the person (e.g., nearby houses/buildings may be recorded based on street address or neighborhood, while distant attractions/landmarks/destinations may be recorded based on zip code, city, or state).

Variable Compressive Spatial Codes

Human brains exhibit even more complex spatial encoding strategies, which vary the encoding rate and precision depending on how emotionally engaging and interesting an experience is. Traumatic, exciting, and/or exhilarating experiences with many surprises are recorded at much higher density and precision than dull, boring, and/or expected experiences. This disclosure applies a similar approach to synthetic systems by representing spatial dimensions as nonlinear manifolds in vector spaces that are not uniformly spaced. Any arbitrary function can be applied to the spatial dimension records to compress or decompress their coding and expression, so as to use more computational dynamic range where there is high information density, and less where information to be encoded is sparse. By analogy, this is why cab drivers can remember detailed maps of every road and alleyway in a city while only remembering a few sparse and far-separated turnings of boring and long rural highways.

Periodic Spatial Codes

Cyclical and periodic spatial recording strategies are also useful to capture, characterize, identify, and predict regular periodic behavior, such repeated path traversals in commutes, regular rounds walked by physicians, regular migratory paths, or daily oceanic feeding column traversal time cyclical spatial path regularities. For example, when developing machine learning systems to predict over what path a person is going to navigate to work, an absolute linear GPS position stamp is less relevant than a periodic spatial map of a regular path that more precisely isolates a position on the regular daily route.

Spatial Code Coordinate Axes System Strategies

There are a broad range of possible spatial code representation strategies in both traditional von Neumann computing architectures as well as newer connectionist computing architectures that involve deep learning and convolutional neural networks (DNNs and CNNs), LSTM networks, recurrent networks, support vector machines (SVMs), and so forth.

Examples of possible spatial coding strategies include the following:
1. universal linear rectangular spatial codes with three coordinate axes (typically x, y, and z);
2. coordinate axes for earth-bound mapping and location (e.g., latitude, longitude, and altitude);
3. allocentric relative position coordinates between objects;
4. egocentric coordinate axes relative to self, such as polar coordinates (e.g., Phi, Theta, Psi) from a zero point at the self.

Any and all of them are integral to, and improve the performance of, efficient machine learning and Al systems designed to interact with people and the natural world. As an example, an intelligent biometrics system could leverage these spatial data representations to recognize, classify, and predict patterns in biometric health data.

Representing Physical Space in the Distributed Knowledge Graph

The distributed knowledge graph (DKG) described throughout this disclosure is also a perfect storage mechanism to reflect how spatial information is stored in the human brain to allow human like spatial navigation and control capabilities in synthetic software and robotic systems. If an application demands spatial computation, additional dimensions can be added to the continuous vector space for each necessary spatial degree of freedom, so that every semantic concept or sensor reading is positioned in the space according to where in space that measurement was encountered. A range of coding strategies are possible and can be tuned to suit specific applications (e.g., linear scaled latitude/longitude/altitude for navigation applications, building coordinate codes for hospital sensor readings, and/or allocentric polar coordinates for local autonomous robotic or vehicle control/grasping or operation).

Machine Learning Using Semantic Concepts Represented with Temporal and Spatial Data

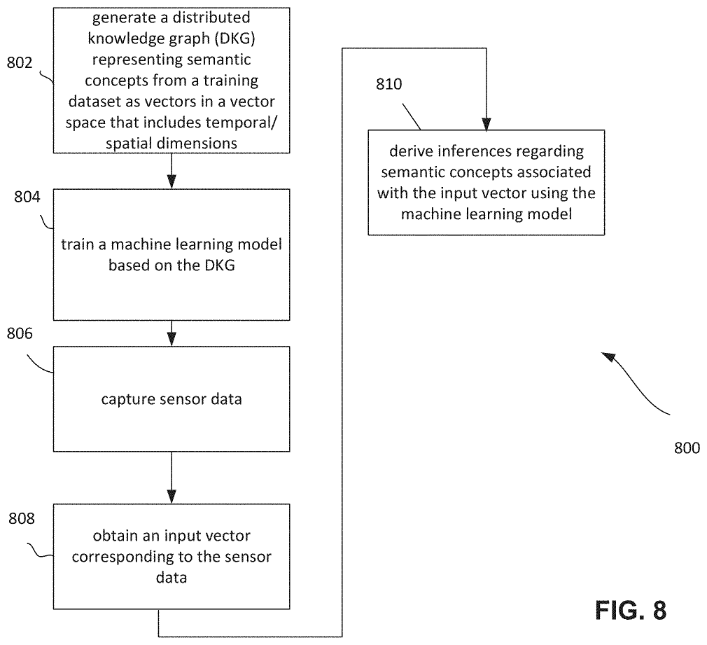

FIG. 8 illustrates a process 800 for deriving machine learning inferences from semantic concepts represented using temporal and spatial data. In various embodiments, process 800 may be implemented using the embodiments and functionality described throughout this disclosure.

The process begins at block 802, where a distributed knowledge graph (DKG) is generated from a training dataset to represent semantic concepts in a vector space that includes temporal/spatial dimensions. In some embodiments, for example, the training dataset may include samples of training data that correspond to various semantic concepts. Moreover, the semantic concepts may be defined based on a set of meta-semantic parameters that describe various characteristics of the samples in the training dataset. In particular, the meta-semantic parameters may include temporal and spatial parameters to indicate when and where the training samples corresponding to the semantic concepts were captured or otherwise occurred (e.g., based on corresponding timestamps and physical location stamps), among other parameters associated with the training samples. In this manner, the DKG data structure may be used to represent the semantic concepts corresponding to the training samples as vectors in a vector space, where the elements of the vectors (and the dimensions of the vector space) correspond to the meta-semantic parameters associated with the semantic concepts.

The process then proceeds to block 804 to train a machine learning model based on the DKG data structure. For example, based on the DKG data structure, a machine learning model may be trained to derive inferences regarding the semantic concepts associated with new (e.g., previously unseen) data samples. Any suitable type of machine learning and/or artificial intelligence techniques may be used, including CNNs, RNNs, LSTMs, and so forth.

The process then proceeds to block 806 to capture new data using one or more sensors (e.g., computer vision sensors, biometric sensors, location/position sensors).

The process then proceeds to block 808 to obtain an input vector corresponding to the newly captured sensor data. In some embodiments, for example, the sensor data may be represented as an input vector with elements that correspond to the same set of meta-semantic parameters used to define the semantic concepts in the DKG data structure. Moreover, certain elements of the input vector may indicate the time and location corresponding to when and where the sensor data was captured.

The process then proceeds to block 810 to derive inferences regarding semantic concepts associated with the input vector using the machine learning model (e.g., by supplying the input vector as input to the machine learning model). In some embodiments, for example, the machine learning model may be used to classify the type of semantic concept(s) represented by the input vector, identify other closely related semantic concepts, generate predictions regarding past or future states, and so forth.

At this point, the process may be complete. In some embodiments, however, the process may restart and/or certain blocks may be repeated. For example, in some embodiments, the process may restart at block 804 to continue training the machine learning model using additional training data, or the process may restart at block 806 to continue capturing new sensor data and deriving inferences using the machine learning model.

Example Embodiments

The examples set forth herein are illustrative and not exhaustive.

Example 1 includes a product comprising one or more tangible computer-readable non-transitory storage media comprising computer-executable instructions operable to, when executed by at least one computer processor, enable the at least one processor to perform: access a distributed knowledge graph (DKG) data structure stored in memory circuitry, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes: a temporal parameter to represent timestamps associated with the plurality of semantic concepts; and a spatial parameter to represent physical locations associated with the plurality of semantic concepts; train a machine learning model to derive inferences associated with the plurality of semantic concepts based on the DKG data structure; obtain an input vector corresponding to data captured by one or more sensors, wherein elements of the input vector correspond to the set of meta-semantic parameters; and derive an inference associated with one or more semantic concepts corresponding to the input vector, wherein the inference is derived based on processing the input vector using the machine learning model.

Example 2 includes the subject matter of Example 1, wherein the temporal parameter is to represent the timestamps based on linear temporal coding.

Example 3 includes the subject matter of Example 1, wherein the temporal parameter is to represent the timestamps based on log scale temporal coding.

Example 4 includes the subject matter of Example 1, wherein the temporal parameter is to represent the timestamps based on variable compressive temporal coding.

Example 5 includes the subject matter of Example 1, wherein the temporal parameter is to represent the timestamps based on periodic temporal coding.

Example 6 includes the subject matter of Example 1, wherein the temporal parameter comprises a plurality of temporal parameters to represent the timestamps based on a plurality of temporal coding formats, wherein the plurality of temporal coding formats comprises two or more of: linear temporal coding; log scale temporal coding; variable compressive temporal coding; or periodic temporal coding.

Example 7 includes the subject matter of Example 1, wherein the spatial parameter is to represent the physical locations based on linear spatial coding.

Example 8 includes the subject matter of Example 1, wherein the spatial parameter is to represent the physical locations based on log scale spatial coding.

Example 9 includes the subject matter of Example 1, wherein the spatial parameter is to represent the physical locations based on variable compressive spatial coding.

Example 10 includes the subject matter of Example 1, wherein the spatial parameter is to represent the physical locations based on periodic spatial coding.

Example 11 includes the subject matter of Example 1, wherein the spatial parameter comprises a plurality of spatial parameters to represent the physical locations based on a plurality of spatial coding formats, wherein the plurality of spatial coding formats comprises two or more of: linear spatial coding; log scale spatial coding; variable compressive spatial coding; or periodic spatial coding.

Example 12 includes a computing device, comprising: memory circuitry to store a distributed knowledge graph (DKG) data structure, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes: a temporal parameter to represent timestamps associated with the plurality of semantic concepts; and a spatial parameter to represent physical locations associated with the plurality of semantic concepts; and processing circuitry to: access the DKG data structure stored in the memory circuitry; train a machine learning model to derive inferences associated with the plurality of semantic concepts based on the DKG data structure; obtain an input vector corresponding to data captured by one or more sensors, wherein elements of the input vector correspond to the set of meta-semantic parameters; and derive an inference associated with one or more semantic concepts corresponding to the input vector, wherein the inference is derived based on processing the input vector using the machine learning model.

Example 13 includes the subject matter of Example 12, further comprising the one or more sensors.

Example 14 includes the subject matter of Example 12, wherein the temporal parameter is to represent the timestamps based on linear temporal coding, log scale temporal coding, variable compressive temporal coding, or periodic temporal coding.

Example 15 includes the subject matter of Example 14, wherein the temporal parameter comprises a plurality of temporal parameters to represent the timestamps based on a plurality of temporal coding formats, wherein the plurality of temporal coding formats comprises two or more of: linear temporal coding; log scale temporal coding; variable compressive temporal coding; or periodic temporal coding.

Example 16 includes the subject matter of Example 12, wherein the spatial parameter is to represent the physical locations based on linear spatial coding, log scale spatial coding, variable compressive spatial coding, or periodic spatial coding.

Example 17 includes the subject matter of Example 16, wherein the spatial parameter comprises a plurality of spatial parameters to represent the physical locations based on a plurality of spatial coding formats, wherein the plurality of spatial coding formats comprises two or more of: linear spatial coding; log scale spatial coding; variable compressive spatial coding; or periodic spatial coding.

Example 18 includes a computer-implemented method of deriving inferences associated with semantic concepts using machine learning, the method including: accessing a distributed knowledge graph (DKG) data structure stored in memory circuitry, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes: a temporal parameter to represent timestamps associated with the plurality of semantic concepts; and a spatial parameter to represent physical locations associated with the plurality of semantic concepts; training a machine learning model to derive inferences associated with the plurality of semantic concepts based on the DKG data structure; obtaining an input vector corresponding to data captured by one or more sensors, wherein elements of the input vector correspond to the set of meta-semantic parameters; and deriving an inference associated with one or more semantic concepts corresponding to the input vector, wherein the inference is derived based on processing the input vector using the machine learning model.

Example 19 includes the subject matter of Example 18, wherein the temporal parameter is to represent the timestamps based on linear temporal coding, log scale temporal coding, variable compressive temporal coding, or periodic temporal coding.

Example 20 includes the subject matter of Example 19, wherein the temporal parameter comprises a plurality of temporal parameters to represent the timestamps based on a plurality of temporal coding formats, wherein the plurality of temporal coding formats comprises two or more of: linear temporal coding; log scale temporal coding; variable compressive temporal coding; or periodic temporal coding.

Example 21 includes the subject matter of Example 18, wherein the spatial parameter is to represent the physical locations based on linear spatial coding, log scale spatial coding, variable compressive spatial coding, or periodic spatial coding.

Example 22 includes the subject matter of Example 21, wherein the spatial parameter comprises a plurality of spatial parameters to represent the physical locations based on a plurality of spatial coding formats, wherein the plurality of spatial coding formats comprises two or more of: linear spatial coding; log scale spatial coding; variable compressive spatial coding; or periodic spatial coding.

Example 23 includes a device to derive inferences associated with semantic concepts using machine learning, the device including: means for accessing a distributed knowledge graph (DKG) data structure stored in memory circuitry, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes: a temporal parameter to represent timestamps associated with the plurality of semantic concepts; and a spatial parameter to represent physical locations associated with the plurality of semantic concepts; means for training a machine learning model to derive inferences associated with the plurality of semantic concepts based on the DKG data structure; means for obtaining an input vector corresponding to data captured by one or more sensors, wherein elements of the input vector correspond to the set of meta-semantic parameters; and means for deriving an inference associated with one or more semantic concepts corresponding to the input vector, wherein the inference is derived based on processing the input vector using the machine learning model.

Example 24 includes the subject matter of Example 23, wherein the temporal parameter is to represent the timestamps based on linear temporal coding, log scale temporal coding, variable compressive temporal coding, or periodic temporal coding.

Example 25 includes the subject matter of Example 23, wherein the spatial parameter is to represent the physical locations based on linear spatial coding, log scale spatial coding, variable compressive spatial coding, or periodic spatial coding.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed.

What is claimed is:

1. A product comprising one or more tangible computer-readable non-transitory storage media comprising computer-executable instructions operable to, when executed by at least one computer processor, enable the at least one processor to:
access a distributed knowledge graph (DKG) data structure stored in memory circuitry, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes:
a temporal parameter to represent timestamps associated with the plurality of semantic concepts; and
a spatial parameter to represent physical locations associated with the plurality of semantic concepts;
train a machine learning model to derive inferences associated with the plurality of semantic concepts based on the DKG data structure;
obtain an input vector corresponding to data captured by one or more sensors, wherein elements of the input vector correspond to the set of meta-semantic parameters; and
derive an inference associated with one or more semantic concepts corresponding to the input vector, wherein the inference is derived based on processing the input vector using the machine learning model.

2. The product of claim 1, wherein the temporal parameter is to represent the timestamps based on linear temporal coding.

3. The product of claim 1, wherein the temporal parameter is to represent the timestamps based on log scale temporal coding.

4. The product of claim 1, wherein the temporal parameter is to represent the timestamps based on variable compressive temporal coding.

5. The product of claim 1, wherein the temporal parameter is to represent the timestamps based on periodic temporal coding.

6. The product of claim 1, wherein the temporal parameter comprises a plurality of temporal parameters to represent the timestamps based on a plurality of temporal coding formats, wherein the plurality of temporal coding formats comprises two or more of:
linear temporal coding;
log scale temporal coding;
variable compressive temporal coding; or
periodic temporal coding.

7. The product of claim 1, wherein the spatial parameter is to represent the physical locations based on linear spatial coding.

8. The product of claim 1, wherein the spatial parameter is to represent the physical locations based on log scale spatial coding.

9. The product of claim 1, wherein the spatial parameter is to represent the physical locations based on variable compressive spatial coding.

10. The product of claim 1, wherein the spatial parameter is to represent the physical locations based on periodic spatial coding.

11. The product of claim 1, wherein the spatial parameter comprises a plurality of spatial parameters to represent the physical locations based on a plurality of spatial coding formats, wherein the plurality of spatial coding formats comprises two or more of:
linear spatial coding;
log scale spatial coding;
variable compressive spatial coding; or
periodic spatial coding.

12. A computing device, comprising:
memory circuitry to store a distributed knowledge graph (DKG) data structure, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes:
a temporal parameter to represent timestamps associated with the plurality of semantic concepts; and
a spatial parameter to represent physical locations associated with the plurality of semantic concepts; and
processing circuitry to:
access the DKG data structure stored in the memory circuitry;
train a machine learning model to derive inferences associated with the plurality of semantic concepts based on the DKG data structure;
obtain an input vector corresponding to data captured by one or more sensors, wherein elements of the input vector correspond to the set of meta-semantic parameters; and
derive an inference associated with one or more semantic concepts corresponding to the input vector, wherein the inference is derived based on processing the input vector using the machine learning model.

13. The computing device of claim 12, further comprising the one or more sensors.

14. The computing device of claim 12, wherein the temporal parameter is to represent the timestamps based on linear temporal coding, log scale temporal coding, variable compressive temporal coding, or periodic temporal coding.

15. The computing device of claim 14, wherein the temporal parameter comprises a plurality of temporal parameters to represent the timestamps based on a plurality of temporal coding formats, wherein the plurality of temporal coding formats comprises two or more of:
linear temporal coding;
log scale temporal coding;
variable compressive temporal coding; or
periodic temporal coding.

16. The computing device of claim 12, wherein the spatial parameter is to represent the physical locations based on linear spatial coding, log scale spatial coding, variable compressive spatial coding, or periodic spatial coding.

17. The computing device of claim 16, wherein the spatial parameter comprises a plurality of spatial parameters to represent the physical locations based on a plurality of spatial coding formats, wherein the plurality of spatial coding formats comprises two or more of:
linear spatial coding;
log scale spatial coding;
variable compressive spatial coding; or
periodic spatial coding.

18. A computer-implemented method of deriving inferences associated with semantic concepts using machine learning, the method including:
accessing a distributed knowledge graph (DKG) data structure stored in memory circuitry, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes:
a temporal parameter to represent timestamps associated with the plurality of semantic concepts; and
a spatial parameter to represent physical locations associated with the plurality of semantic concepts;
training a machine learning model to derive inferences associated with the plurality of semantic concepts based on the DKG data structure;
obtaining an input vector corresponding to data captured by one or more sensors, wherein elements of the input vector correspond to the set of meta-semantic parameters; and
deriving an inference associated with one or more semantic concepts corresponding to the input vector, wherein the inference is derived based on processing the input vector using the machine learning model.

19. The computer-implemented method of claim 18, wherein the temporal parameter is to represent the timestamps based on linear temporal coding, log scale temporal coding, variable compressive temporal coding, or periodic temporal coding.

20. The computer-implemented method of claim 19, wherein the temporal parameter comprises a plurality of temporal parameters to represent the timestamps based on a plurality of temporal coding formats, wherein the plurality of temporal coding formats comprises two or more of:
linear temporal coding;
log scale temporal coding;
variable compressive temporal coding; or
periodic temporal coding.

21. The computer-implemented method of claim 18, wherein the spatial parameter is to represent the physical locations based on linear spatial coding, log scale spatial coding, variable compressive spatial coding, or periodic spatial coding.

22. The computer-implemented method of claim 21, wherein the spatial parameter comprises a plurality of spatial parameters to represent the physical locations based on a plurality of spatial coding formats, wherein the plurality of spatial coding formats comprises two or more of:
linear spatial coding;
log scale spatial coding;
variable compressive spatial coding; or
periodic spatial coding.

23. A device to derive inferences associated with semantic concepts using machine learning, the device including:
means for accessing a distributed knowledge graph (DKG) data structure stored in memory circuitry, wherein the DKG data structure represents a plurality of semantic concepts associated with a training dataset as a set of vectors in a vector space, wherein elements of the set of vectors correspond to a set of meta-semantic parameters associated with the plurality of semantic concepts, wherein the set of meta-semantic parameters includes:
a temporal parameter to represent timestamps associated with the plurality of semantic concepts; and
a spatial parameter to represent physical locations associated with the plurality of semantic concepts;
means for training a machine learning model to derive inferences associated with the plurality of semantic concepts based on the DKG data structure;
means for obtaining an input vector corresponding to data captured by one or more sensors, wherein elements of the input vector correspond to the set of meta-semantic parameters; and
means for deriving an inference associated with one or more semantic concepts corresponding to the input vector, wherein the inference is derived based on processing the input vector using the machine learning model.

24. The device of claim 23, wherein the temporal parameter is to represent the timestamps based on linear temporal coding, log scale temporal coding, variable compressive temporal coding, or periodic temporal coding.

25. The device of claim 23, wherein the spatial parameter is to represent the physical locations based on linear spatial coding, log scale spatial coding, variable compressive spatial coding, or periodic spatial coding.
